(19) United States
(12) Patent Application Publication
(10) Pub. No.: US 2024/0126720 A1
(43) Pub. Date: Apr. 18, 2024

(54) PATHNAME RECOMMENDATIONS WHEN SAVING, RENAMING OR MOVING FILES

(71) Applicant: International Business Machines Corporation, Armonk, NY (US)

(72) Inventors: Raghuveer Prasad Nagar, Durham, NC (US); Dinesh Kumar Bhudavaram, San Jose, CA (US); Jagadesh Ramaswamy Hulugundi, San Francisco, CA (US); Megha Jain, Raleigh, NC (US)

(21) Appl. No.: 18/046,054

(22) Filed: Oct. 12, 2022

(51) Int. Cl. G06F 16/16; G06F 16/13

(52) U.S. Cl. CPC G06F 16/166; G06F 16/13

(57) ABSTRACT

A computer-implemented method for saving, renaming, or moving a file includes receiving a request to save, rename or move a file, determining real-time context data and meta-data for the file in response to receiving the request to save, rename or move the file, generating a suggested pathname using the real-time context data and presenting the suggested pathname to a user. The suggested pathname may include a folder or directory name and a filename. The method may also include enabling the user to edit and approve the suggested pathname. Examples of context data include a password hint for the file, storage attributes for the file, collaboration data for the file, calendar data for the user, a file naming policy for an organization, real-time IoT data, and a topic determined from content within the file. A corresponding system and computer program product for executing the above method are also disclosed herein.

### BACKGROUND

The subject matter disclosed herein relates generally to recommending pathnames for files in response to users saving, renaming or moving files.

The requirement by computing systems for users to determine the name and storage location of files places a burden on users that often results in poor choices.

### SUMMARY OF THE INVENTION

A computer-implemented method for saving, renaming, or moving a file includes receiving a request to save, rename or move a file, determining real-time context data and meta-data for the file in response to receiving the request to save, rename or move the file, generating a suggested pathname using the real-time context data and presenting the suggested pathname to a user. The suggested pathname may include a folder or directory name and a filename. The method may also include enabling the user to edit and approve the suggested pathname. Examples of context data include a password hint for the file, storage attributes for the file, collaboration data for the file, calendar data for the user, a file naming policy for an organization, real-time IoT data, and a topic determined from content within the file. A corresponding system and computer program product for executing the above method are also disclosed herein.

The corresponding system for saving, renaming, or moving a file includes a file management module configured to receive a request to save, rename or move a file and generate a request to collect context information for the file in response to the request to save, rename, or move the file. The system also includes a context collection module configured to determine real-time context data and meta-data for the file in response to the request to collect context information for the file. The file management module may be configured to generate a suggested pathname using the real-time context data. The system also includes a user interface module configured to initiate presentation of the suggested pathname to the user.

### BRIEF DESCRIPTION OF THE DRAWINGS

In order that the advantages of the embodiments of the invention will be readily understood, a more particular description of the embodiments briefly described above will be rendered by reference to specific embodiments that are illustrated in the appended drawings. Understanding that these drawings depict only some embodiments and are not therefore to be considered to be limiting of scope, the embodiments will be described and explained with additional specificity and detail through the use of the accompanying drawings, in which:

FIG. 1 is a block diagram of one example of a computing environment where the present invention may be deployed;

FIG. 2 is a flowchart of one example of a pathname determination method in accordance with at least one embodiment disclosed herein;

FIG. 3 is a table of various examples of pathnames determined in accordance with at least one embodiment disclosed herein;

FIG. 4 is an illustration of one example of a pathname dialog box in accordance with at least one embodiment disclosed herein;

FIG. 5A is a block diagram illustrating various portions of a computing environment in accordance with at least one embodiment disclosed herein; and

FIG. 5B is a block diagram illustrating one example of a computing stack in accordance with at least one embodiment disclosed herein.

### DETAILED DESCRIPTION OF THE INVENTION

One of ordinary skill in the art will appreciate that references throughout this specification to “one embodiment,” “an embodiment,” or similar language means that a particular feature, structure, or characteristic described in connection with the embodiment is included in at least one embodiment. Thus, appearances of the phrases “in one embodiment,” “in an embodiment,” and similar language throughout this specification may, but do not necessarily, all refer to the same embodiment, but mean “one or more but not all embodiments” unless expressly specified otherwise. The terms “including,” “comprising,” “having,” and variations thereof mean “including but not limited to” unless expressly specified otherwise. An enumerated listing of items does not imply that any or all of the items are mutually exclusive and/or mutually inclusive, unless expressly specified otherwise. The terms “a,” “an,” and “the” also refer to “one or more” unless expressly specified otherwise.

One of skill in the art will appreciate that files saved by users may be physically local or stored remotely (e.g., via the cloud). While saving a file the first time, the user must enter a name for the file. A user may also rename an existing file. If a file is shared with other users, those users also may save the file in their respective systems, which also could be local or on-cloud systems. Files may also remain in-transit. For example, when a file is sent by a user to another user as an email attachment, the file remains in-transit between the time the email is sent by the first user and the time the email is received by the second user.

One issue is that when entering the name and location of the file (when the user saves it first time or renames it), the user is required to immediately think of an appropriate name and place for the file. Many times, users spend considerable time and effort in coming up with an appropriate location and file name. For example, the first option for the file name (that the user thought of) may be inappropriate or sub-optimal (e.g., too long for the user or for transfer to another system). Furthermore, file naming standards and/or conventions (e.g., communicated by the organization) may need to be considered. Password protection and the remembering of passwords may also be an issue.

To address this to a limited extent, operating systems and software offer default naming based on the starting text/content of the file. However, this (starting text) is often not useful or appropriate for deciding a file name, and users end up having to come up with an appropriate location and file name. Furthermore, such an approach (starting text) does not work when the file is without text (for example, when the file has only images). The technology and solutions disclosed herein address the above issues.

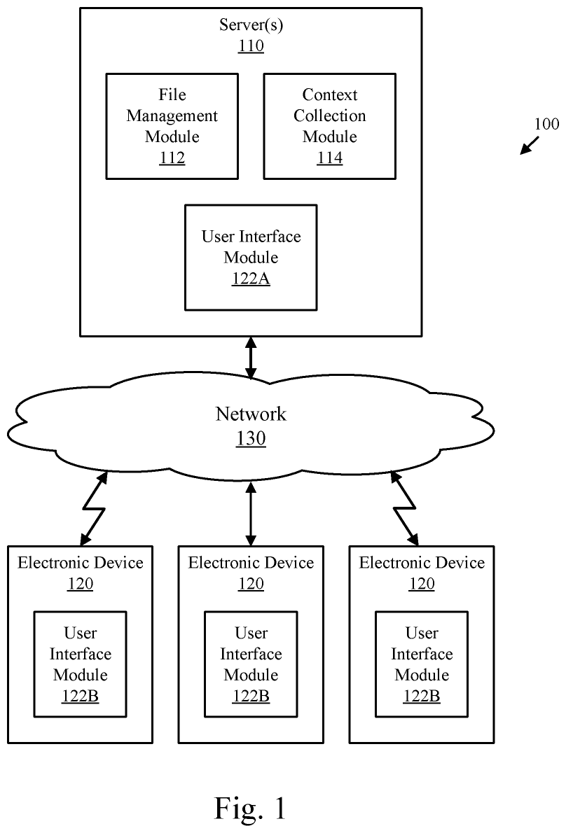

FIG. 1 is a block diagram of one example of a computing environment 100 where the present invention may be deployed. As depicted, the computing environment 100 includes one or more servers 110 and various electronic devices 120 interconnected via one or more networks 130. The computing environment 100 enables users of the electronic devices 120 to access computing services provided by the servers 110.

The electronic devices 120 may have various applications installed thereon (not shown) that enable users of those devices to leverage computing services (not shown) provided by the servers 110. For example, the servers 110 may be cloud servers that provide a wide variety of scalable services to enterprise users. The depicted servers 110 provide file management services via one or more file management modules 112 and context collection services via one or more context collection modules 114.

The file management modules 112 and the context collection modules 114 may function cooperatively to provide users of the electronic devices 120 intelligent options for determining the names and locations of files (i.e., the pathnames) used by the users. The options may be presented to the users via the user interface modules 122.

Depending on the computing environment, the depicted modules 112, 114 and 122 may reside partially or wholly on the servers 110 or the electronic devices (clients) 120. In the depicted embodiment, the user interface modules 122 are partitioned into a server portion 122A and a client portion 122B. In another embodiment, the user interface modules 122 reside wholly on the electronic devices 120.

The file management module 112 may receive request to save, rename or move a file from an application or utility executed by a user of an electronic device 120. In response thereto, the file management module 112 may generate a request to the context collection module 114 to collect context information for the file. In response thereto, the context collection module 114 may collect real-time context data for the file.

The context collection module 114 may collect context data via a variety of methods. For example, image processing techniques may be used to extract features/metadata from each image and/or image-frame within a video. OCR methods can be used to extract text from images and portable documents. Speech recognition may be used to extract text from audio files. Regardless of the source of context data, deep learning and natural language processing techniques can be used to classify the contents. The context collection module 114 may also rank or score the collected context data (e.g., via machine learning) according to relevance and/or (accuracy) confidence.

The file management module 112 may receive the real-time context data and generate one or more suggested pathnames therefrom. The suggested pathnames may be presented to the user via the user interface module 122.

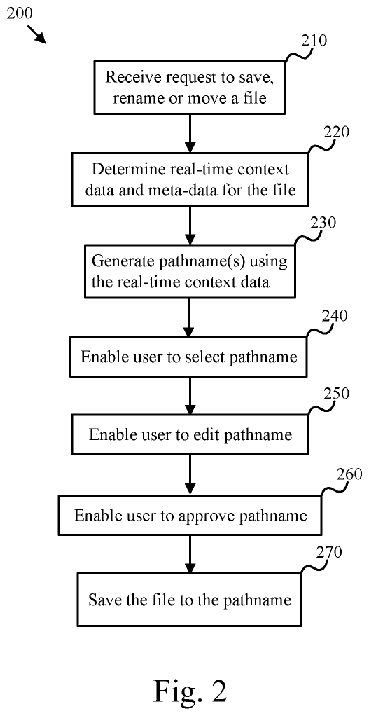

FIG. 2 is a flowchart of one example of a pathname determination method 200 in accordance with at least one embodiment disclosed herein. As depicted, the pathname determination method 200 includes receiving (210) a request to save, rename or move a file, determining (220) context data for the file, generating (230) one or more suggested pathnames, enabling a user to select (240), edit (250), and approve (260) a pathname and saving (270) the file to the pathname. The pathname determination method 200 helps users determine appropriate locations and filenames for storing their files.

Receiving (210) a request to save, rename or move a file may include receiving a message from an application or utility executed by a user of an electronic device 120. Determining (220) context data for the file may include determining context data and meta-data for the file that is to be saved, renamed or moved. The context data and meta-data may be collected in real-time by the context collection module 114.

Generating (230) one or more suggested pathnames may include using the context data and meta-data to come up with suggested pathnames that reflect the context for the file. Enabling a user to select (240) a pathname may include presenting multiple suggested pathnames to the user and providing a user interface that enables selection of one or more of the suggested pathnames. Enabling a user to edit (250) a pathname may include populating a text editor with the selected pathname(s) so that the user can edit the pathname(s). The results of the user edits may be provided to the file management module 112 and/or context collection module 114 to enable subsequent pathname recommendations based on usage.

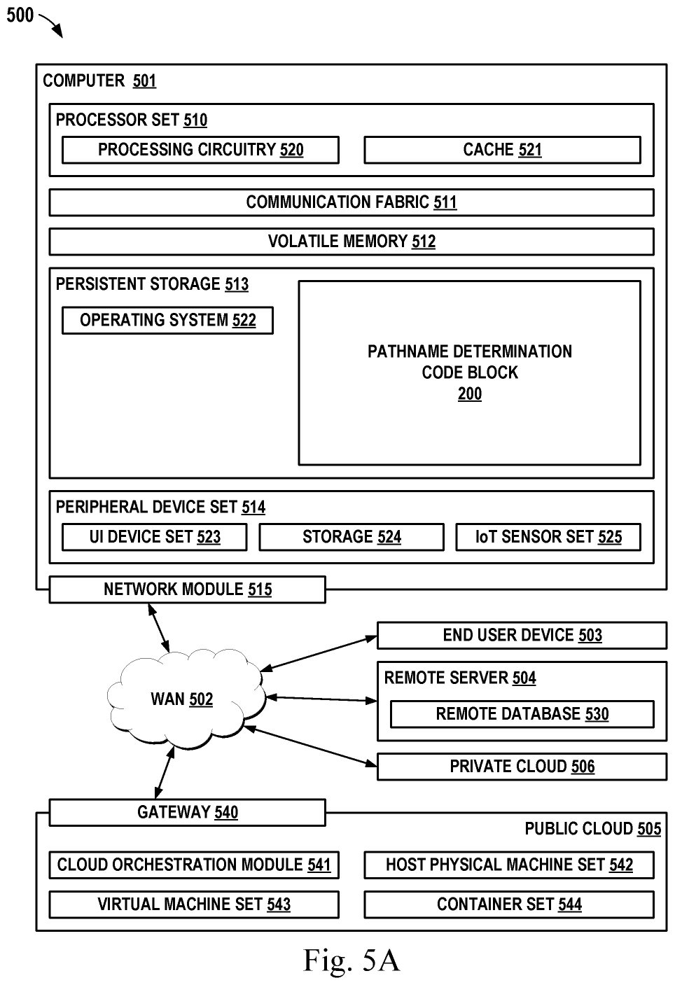

Enabling a user to approve (260) a pathname may include providing user interface elements that enable the user to approve the selected, and potentially edited, pathname(s) to produce one or more approved pathnames. See FIG. 4 for an example. Saving (270) the file to the pathname may include conducting a save, rename or move operation that places the file at the location and filename specified by the pathname.

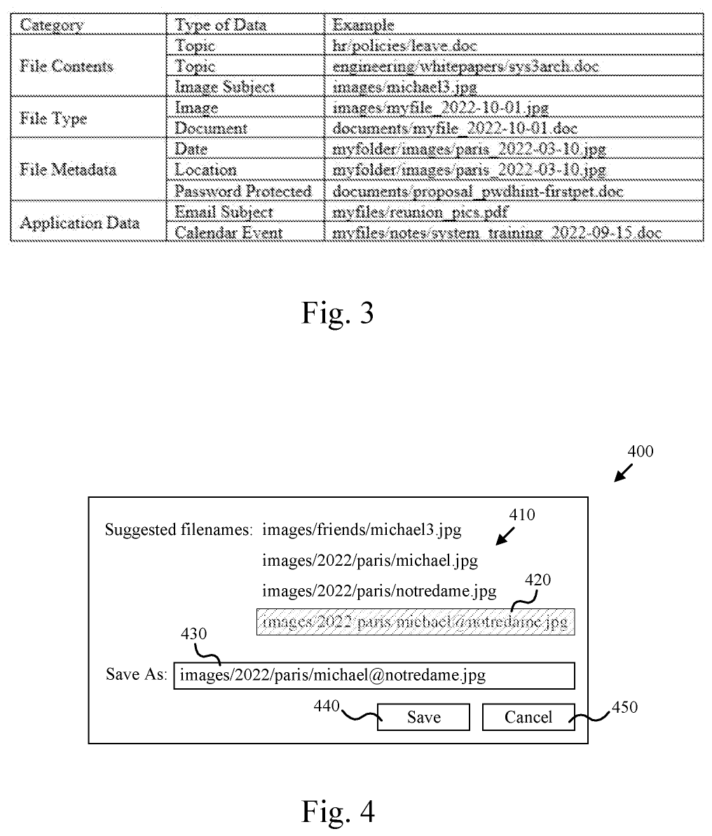

FIG. 3 is a table of various examples of pathnames determined in accordance with at least one embodiment disclosed herein. Example are provided for several categories of context information used to suggest pathnames including file contents, file types, file metadata and application data. Some of the examples use multiple sources of context information. For example, the pathname ‘myfolder/images/paris_2022-03-10.jpg’ may be formed using the type of file being stored as well as the date the file was created, and location metadata associated with the file.

FIG. 4 is an illustration of one example of a pathname dialog box 400 in accordance with at least one embodiment disclosed herein. As depicted, the pathname dialog box 400 includes various suggested pathnames 410, a selected pathname 420, a pathname editor 430, a save button 440 and a cancel button 450. The pathname dialog box 400 enables users to select, edit and approve a suggested pathname.

The suggested pathnames 410 may be generated using context information for the file such as the user, the application and system used to generate the file, the enterprise and policies the user is associated with, and the like. The selected pathname 420 may be selected from the suggested pathnames 410. For example, a user may click on one of the suggested pathnames 410 resulting in the selected pathname being highlighted and entered into the pathname editor 430. The user may edit the pathname, if desired, and then approve the pathname by clicking on the save button 440. Alternately, the user may cancel the pathname selection and file saving process via the cancel button 450.

The suggested pathnames 410 may be generated based on the real-time context derived out of the file contents, file metadata and user data. Various examples, that are not mutually exclusive, are presented below:

In one example, an organization may use a publicly accessible cloud for marketing documents, and a private or highly secure cloud for other documents. When a user saves a presentation on the publicly accessible cloud, one or more of the suggested pathnames 410 may include a prefix or suffix like “Marketing”. Other parts of the file name or location can be recommended based on the file contents or metadata.

In another example, when a user tries to save a log file which is password protected, one or more of the suggested pathnames 410 may include a prefix or suffix like “PasswordProtected”.

In another example, when User A receives an email from User B who is from the same college class, with subject as “Reunion Pics” and 3 attached photos (e.g., 1.jpg, 2.jpg and 3.jpg), one or more of the suggested pathnames 410 may include a prefix or suffix like “Reunion”.

In another example, when a user tries to save a presentation on commerce for new students at a post-graduate management school one or more of the suggested pathnames 410 may include a suggested pathname such as “Presentations/Commerce/IntroForManagementStudents.ppt”.

In another example, when a user tries to save a presentation on using a Hybrid Cloud as part of employee training one or more of the suggested pathnames 410 may include a filename such as “HCloudIntro” because the employees tend to use mobile phones during training and shorter filenames are preferred for mobile phones.

In another example, a user tries to save a Word document after copying most/all of the text from a file called “HRPolicies.docx”, so the suggested pathnames 410 may include a filename prefix or suffix such as “HRPolicySnapshot”.

In another example, a user tries to save a Word document after copying most/all the contents from an application name WorkApp, so the suggested pathnames 410 may include a filename prefix or suffix such as “WorkAppSnapshot”.

In other examples, the suggested pathnames 410 include an indication of password protection and/or a password hint. For example, a user may receive a confidential document with their date of birth as password. When the user saves or moves the document, one or more of the suggested pathnames 410 may include a filename the password hint “DOBDDMMYYYY” as a suffix. In another example, a user receives a bank document having password protection over email on 31-Dec. When the user saves the document, one or more of the suggested pathnames 410 include “ReferToEmailOn31Dec” as a suffix.

In other examples, the suggested pathnames 410 are based on real-time IoT data such as environmental conditions data and location data. For example, a user may be travelling and has captured a few notes which belong to various topics. In such cases, the suggested pathnames 410 can include a filename such as “TravelToRainyParisNotes.txt”. The suggested pathnames 410 may be based on calendar data along with location data. For example, when a user's calendar indicates ‘Machine Learning Training 10-4 @ Manhattan Hilton’ and the user's location data indicates that the user is at the Manhattan Hilton during the calendared time, the suggested pathnames 410 can include a recommended prefix/suffix like “NYC_ML_Training” when the user elects to save a file.

In another example, User A receives an email from User B who is from the same college class, with subject as “Reunion Pics”. The email has 3 pictures attached as 1.jpg, 2.jpg and 3.jpg. When User A saves the pics in a “College Pics” folder, the suggested pathnames 410 include a child folder named “College Pics/Reunion”.

One of skill in the art will appreciate that presenting suggested pathnames to users can reduce intentional or unintentional user errors in determining the location and names of files. Furthermore, the burden on users is reduced and productivity and user satisfaction can be increased. Furthermore, file placement and name can be more predictable resulting in more efficient file searching. Naming collisions can also be reduced.

In one scenario, a user ‘Binny’ has a baby daughter ‘Jane’ at home. Binny regularly takes photos on her smart phone e.g., when Jane crawls, plays with toys, smiles, cries, etc. Binny also captures Jane in various activities in different colors and types of clothing such as frocks, winter wear, dresses, pants, etc. With time the number of photos increases considerably. Binny copies the best pictures on her personal cloud account. Without pathname suggestions the photos get saved with a default naming convention like “IMG000007.jpeg” and Binny is required to manually update the filename and/or location based on the content of the picture. This consumes considerable amount of time and becomes unmanageable. However, with pathname recommendations the photos can be automatically organized into directories with informative filenames. For example, when saving a photo of Jane in a purple frock and smiling at her cousin Sara holding an umbrella, the suggested pathnames 410 may include:
1) “Jane\BabyPhotos\InPurpleFrockSmilingAtSara.jpeg,”
2) “Jane\BabyPhotos\WithSara.jpeg” and
3) “Cousins\Sara\WithJaneHoldingUmbrella.jpeg”
   In one embodiment, Binny may save the photo to multiple locations by selecting each desired option (e.g., pathnames 1 and 3).

In one scenario, a user or an enterprise signs up for the service. The sign-up process involves processing of user data like calendar and/or enterprise standards, policies, and conventions. The signup process may assure that the user or the enterprise understands the data privacy statements and agreements under the consumption of the services. User files may be associated with the sign-up process including new, existing and downloaded files. During the sign-up process, the file management module 112 may have access to:
1) The file directory structure including parent and sub directories on any of the user's electronic devices 120
2) Enterprise assets (servers), file naming policies, standards and/or conventions
3) Target storage locations and file formats(text, video, document, excel, etc.)
4) Historical preferences of file naming patterns and related knowledge corpus
5) Corpus of existing files on the file directory structure and status (password-protected, confidential, classified, private or public)
6) Knowledge corpus of end user's linguistic choices and preferences through various digital sources of content

The ability to select a recommended pathname is triggered when a user downloads/stores/copies an existing file or attempts to save a new file with an application or utility. In response to such a triggering event, real-time context data and meta-data is collected to enable generation of useful recommended pathnames. For example, context data based on context of
1) Receipt of file (Ex: Jane sending a reunion photo image on email)
2) Target location of file being stored (ex: target is a cloud storage location which has file name length constraint for image as 18 characters and allowed/restricted characters in file name string)
3) User collaboration across digital platforms and source of content file
4) Devices of individual user and related operating system (Ex: mobile user on Android or an enterprise user on VM and related operating system)
5) File sensitivity (e.g., confidential or password-protected) and related information on password pattern (Ex: Password is Last Name appended with employee joining date. John Will's offer letter will be password protected with Will18Nov2009)
6) System builds for the file being saved/renamed/copied

One of skill in the art will appreciate the utility and effectiveness of the solutions disclosed herein. Users can be prompted with suggested pathnames that result in more effective filenames and locations with less cognitive effort.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

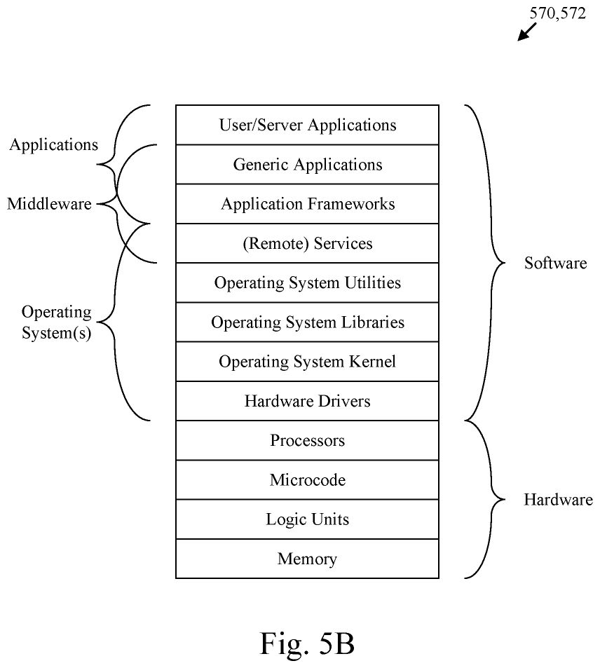

FIG. 5A is a block diagram illustrating various portions of a computing environment 500 in accordance with at least one embodiment disclosed herein. Computing environment 500 contains an example of an environment for the execution of at least some of the computer code involved in performing the inventive methods, such as pathname determination code block 201 (corresponding to the pathname determination method 200 shown in FIG. 2). In some embodiments, portions of code block 201 reside within the operating system 522. In addition to block 201, computing environment 500 includes, for example, computer 501, wide area network (WAN) 502, end user device (EUD) 503, remote server 504, public cloud 505, and private cloud 506. In this embodiment, computer 501 includes processor set 510 (including processing circuitry 520 and cache 521), communication fabric 511, volatile memory 512, persistent storage 513 (including operating system 522 and block 200, as identified above), peripheral device set 514 (including user interface (UI) device set 523, storage 524, and Internet of Things (IoT) sensor set 525), and network module 515. Remote server 504 includes remote database 530. Public cloud 505 includes gateway 540, cloud orchestration module 541, host physical machine set 542, virtual machine set 543, and container set 544.

COMPUTER 501 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 530. As is well understood in the art of computer technology, and depending upon the technology, performance of a computer-implemented method may be distributed among multiple computers and/or between multiple locations. On the other hand, in this presentation of computing environment 500, detailed discussion is focused on a single computer, specifically computer 501, to keep the presentation as simple as possible. Computer 501 may be located in a cloud, even though it is not shown in a cloud in FIG. 5A. On the other hand, computer 501 is not required to be in a cloud except to any extent as may be affirmatively indicated.

PROCESSOR SET 510 includes one, or more, computer processors of any type now known or to be developed in the future. Processing circuitry 520 may be distributed over multiple packages, for example, multiple, coordinated integrated circuit chips. Processing circuitry 520 may implement multiple processor threads and/or multiple processor cores. Cache 521 is memory that is located in the processor chip package(s) and is typically used for data or code that should be available for rapid access by the threads or cores running on processor set 510. Cache memories are typically organized into multiple levels depending upon relative proximity to the processing circuitry. Alternatively, some, or all, of the cache for the processor set may be located “off chip.” In some computing environments, processor set 510 may be designed for working with qubits and performing quantum computing.

Computer readable program instructions are typically loaded onto computer 501 to cause a series of operational steps to be performed by processor set 510 of computer 501 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 521 and the other storage media discussed below. The program instructions, and associated data, are accessed by processor set 510 to control and direct performance of the inventive methods. In computing environment 500, at least some of the instructions for performing the inventive methods may be stored in block 201 in persistent storage 513.

COMMUNICATION FABRIC 511 is the signal conduction path that allows the various components of computer 501 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

VOLATILE MEMORY 512 is any type of volatile memory now known or to be developed in the future. Examples include dynamic type random access memory (RAM) or static type RAM. Typically, volatile memory 512 is characterized by random access, but this is not required unless affirmatively indicated. In computer 501, the volatile memory 512 is located in a single package and is internal to computer 501, but, alternatively or additionally, the volatile memory may be distributed over multiple packages and/or located externally with respect to computer 501.

PERSISTENT STORAGE 513 is any form of non-volatile storage for computers that is now known or to be developed in the future. The non-volatility of this storage means that the stored data is maintained regardless of whether power is being supplied to computer 501 and/or directly to persistent storage 513. Persistent storage 513 may be a read only memory (ROM), but typically at least a portion of the persistent storage allows writing of data, deletion of data and re-writing of data. Some familiar forms of persistent storage include magnetic disks and solid state storage devices. Operating system 522 may take several forms, such as various known proprietary operating systems or open source Portable Operating System Interface-type operating systems that employ a kernel. The code included in block 201 typically includes at least some of the computer code involved in performing the inventive methods.

PERIPHERAL DEVICE SET 514 includes the set of peripheral devices of computer 501. Data communication connections between the peripheral devices and the other components of computer 501 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 523 may include components such as a display screen, speaker, microphone, wearable devices (such as goggles and smart watches), keyboard, mouse, printer, touchpad, game controllers, and haptic devices. Storage 524 is external storage, such as an external hard drive, or insertable storage, such as an SD card. Storage 524 may be persistent and/or volatile. In some embodiments, storage 524 may take the form of a quantum computing storage device for storing data in the form of qubits. In embodiments where computer 501 is required to have a large amount of storage (for example, where computer 501 locally stores and manages a large database) then this storage may be provided by peripheral storage devices designed for storing very large amounts of data, such as a storage area network (SAN) that is shared by multiple, geographically distributed computers. IoT sensor set 525 is made up of sensors that can be used in Internet of Things applications. For example, one sensor may be a thermometer and another sensor may be a motion detector.

NETWORK MODULE 515 is the collection of computer software, hardware, and firmware that allows computer 501 to communicate with other computers through WAN 502. Network module 515 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 515 are performed on the same physical hardware device. In other embodiments (for example, embodiments that utilize software-defined networking (SDN)), the control functions and the forwarding functions of network module 515 are performed on physically separate devices, such that the control functions manage several different network hardware devices. Computer readable program instructions for performing the inventive methods can typically be downloaded to computer 501 from an external computer or external storage device through a network adapter card or network interface included in network module 515.

WAN 502 is any wide area network (for example, the internet) capable of communicating computer data over non-local distances by any technology for communicating computer data, now known or to be developed in the future. In some embodiments, the WAN 502 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 503 is any computer system that is used and controlled by an end user (for example, a customer of an enterprise that operates computer 501), and may take any of the forms discussed above in connection with computer 501. EUD 503 typically receives helpful and useful data from the operations of computer 501. For example, in a hypothetical case where computer 501 is designed to provide a recommendation to an end user, this recommendation would typically be communicated from network module 515 of computer 501 through WAN 502 to EUD 503. In this way, EUD 503 can display, or otherwise present, the recommendation to an end user. In some embodiments, EUD 503 may be a client device, such as thin client, heavy client, mainframe computer, desktop computer and so on.

REMOTE SERVER 504 is any computer system that serves at least some data and/or functionality to computer 501. Remote server 504 may be controlled and used by the same entity that operates computer 501. Remote server 504 represents the machine(s) that collect and store helpful and useful data for use by other computers, such as computer 501. For example, in a hypothetical case where computer 501 is designed and programmed to provide a recommendation based on historical data, then this historical data may be provided to computer 501 from remote database 530 of remote server 504.

PUBLIC CLOUD 505 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 505 is performed by the computer hardware and/or software of cloud orchestration module 541. The computing resources provided by public cloud 505 are typically implemented by virtual computing environments that run on various computers making up the computers of host physical machine set 542, which is the universe of physical computers in and/or available to public cloud 505. The virtual computing environments (VCEs) typically take the form of virtual machines from virtual machine set 543 and/or containers from container set 544. It is understood that these VCEs may be stored as images and may be transferred among and between the various physical machine hosts, either as images or after instantiation of the VCE. Cloud orchestration module 541 manages the transfer and storage of images, deploys new instantiations of VCEs and manages active instantiations of VCE deployments. Gateway 540 is the collection of computer software, hardware, and firmware that allows public cloud 505 to communicate through WAN 502.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 506 is similar to public cloud 505, except that the computing resources are only available for use by a single enterprise. While private cloud 506 is depicted as being in communication with WAN 502, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 505 and private cloud 506 are both part of a larger hybrid cloud.

FIG. 5B is a block diagram illustrating one example of a computing stack 570 in accordance with at least one embodiment disclosed herein. As depicted, the computing stack 570 includes a number of computing layers 572 used for conducting computing operations. In the depicted embodiment, the layers include hardware layers and software layers. The various software layers include operating system layers associated with executing one or more operating systems, middleware layers associated with executing middleware that expands and/or improves the functionality of hardware layers, and executing operating system(s). The software layers may also include various application-specific layers. The application-specific layers may include application frameworks that further expand on, and/or improve upon, the functionality of hardware layers and operating system layers.

The memory layer may include volatile memory, non-volatile memory, persistent storage and hardware associated with controlling such memory. The logic units may include CPUs, arithmetic units, graphic processing units, and hardware associated with controlling such units. The microcode layer may include executable instructions for controlling the processing flow associated with moving data between memory and the logic units. The processor layer may include instruction fetch units, instruction decode units, and the like that enable execution of processing instructions and utilization of the underlying hardware layers.

The hardware drivers (also known as the hardware abstraction layer) may include executable code that enables an operating system to access and control storage devices, DMA hardware, I/O buses, peripheral devices, and other hardware associated with a computing environment. The operating system kernel layer may receive I/O requests from higher layers and manage memory and other hardware resources via the hardware drivers. The operating system kernel layer may also provide other functions such as inter-process communication and file management.

Operating system libraries and utilities may expand the functionality provided by the operating system kernel and provide an interface for accessing those functions. Libraries are typically leveraged by higher layers of software by linking library object code into higher level software executables. In contrast, operating system utilities are typically standalone executables that can be invoked via an operating system shell that receives commands from a user and/or a script file. Examples of operating system libraries include file I/O libraries, math libraries, memory management libraries, process control libraries, data access libraries, and the like. Examples of operating system utilities include anti-virus managers, disk formatters, disk defragmenters, file compressors, data or file sorters, data archivers, memory testers, program installers, package managers, network utilities, system monitors, system profilers, and the like.

Services are often provided by a running executable or process that receives local or remote requests from other processes or devices called clients. A computer running a service is often referred to as a server. Examples of servers include database servers, file servers, mail servers, print servers, web servers, game servers, and application servers.

Application frameworks provide functionality that is commonly needed by applications and include system infrastructure frameworks, middleware integration, frameworks, enterprise application frameworks, graphical rendering frameworks, and gaming frameworks. An application framework may support application development for a specific environment or industry. In some cases, application frameworks are available for multiple operating systems and providing a common programming interface to developers across multiple platforms.

Generic applications include applications that are needed by most users. Examples of generic applications include mail applications, calendaring and scheduling applications, and web browsers. Such applications may be automatically included with an operating system.

One of skill in the art will appreciate that an improvement to any of the depicted layers, or similar layers that are not depicted herein, results in an improvement to the computer itself including the computer 501 and/or the end user devices 503. One of skill in the art will also appreciate that the depicted layers are given by way of example are not representative of all computing devices. Nevertheless, the concept of improving the computer itself by improving one or more functional layers is essentially universal.

The executables and programs described herein are identified based upon the application or software layer for which they are implemented in a specific embodiment of the present invention. However, it should be appreciated that any particular program nomenclature herein is used merely for convenience, and thus the present invention should not be limited to use solely in any specific identified application or software layer.

The features, advantages, and characteristics of the embodiments described herein may be combined in any suitable manner. One skilled in the relevant art will recognize that the embodiments may be practiced without one or more of the specific features or advantages of a particular embodiment. In other instances, additional features and advantages may be recognized in certain embodiments that may not be present in all embodiments.

Some of the functional units described in this specification may have been labeled as modules, in order to more particularly emphasize their implementation independence. For example, a module may be implemented as a hardware circuit comprising custom VLSI circuits or gate arrays, off-the-shelf semiconductors such as logic chips, transistors, or other discrete components. A module may also be implemented in programmable hardware devices such as field programmable gate arrays, programmable array logic, programmable logic devices, or the like.

Modules may also be implemented in software for execution by various types of processors. An identified module of program instructions may, for instance, comprise one or more physical or logical blocks of computer instructions which may, for instance, be organized as an object, procedure, or function. Nevertheless, the executables of an identified module need not be physically located together, but may comprise disparate instructions stored in different locations which, when joined logically together, comprise the module and achieve the stated purpose for the module.

In the preceding description, numerous specific details are provided, such as examples of programming, software modules, user selections, network transactions, database queries, database structures, hardware modules, hardware circuits, hardware chips, etc., to provide a thorough understanding of embodiments. One skilled in the relevant art will recognize, however, that embodiments may be practiced without one or more of the specific details, or with other methods, components, materials, and so forth. In other instances, well-known structures, materials, or operations are not shown or described in detail to avoid obscuring aspects of an embodiment.

The description of elements in each figure may refer to elements of proceeding figures. Like numbers refer to like elements in all figures, including alternate embodiments of like elements. The embodiments may be practiced in other specific forms. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

1. A computer-implemented method for saving, renaming, or moving a file, the method comprising:
receiving a request to save, rename or move a file;
determining real-time context data and meta-data for the file in response to receiving the request to save, rename or move the file;
generating a suggested pathname using the real-time context data and meta-data;
presenting the suggested pathname to a user; and
wherein the suggested pathname comprises a folder or directory name and a filename.

2. The method of claim 1, wherein the folder or directory name is determined, at least in part, based on the filetype for the file.

3. The method of claim 1, further comprising enabling the user to edit the suggested pathname.

4. The method of claim 1, further comprising enabling the user to approve the suggested pathname.

5. The method of claim 4, further comprising saving the file to the suggested pathname in response to the user approving the suggested pathname.

6. The method of claim 1, wherein the context data comprises one or more of a password hint for the file, storage attributes for the file, collaboration data for the file, calendar data for the user, and a file naming policy for an organization.

7. The method of claim 1, wherein the context data comprises a topic determined from content within the file.

8. The method of claim 7, wherein the content comprises one or more of text, an image, and video.

9. The method of claim 1, wherein the context data comprises real-time IoT data.

10. The method of claim 7, wherein the real-time IoT data comprises current location data for the user, or current environmental conditions.

11. The method of claim 1, further comprising presenting multiple suggested pathnames to the user.

12. A computer program product for saving, renaming, or moving a file, the computer program product comprising a computer readable storage medium having program instructions embodied therewith, wherein the computer readable storage medium is not a transitory signal per se, the program instructions executable by a processor to cause the processor to conduct a method comprising:
receiving a request to save, rename or move a file;
determining real-time context data and meta-data for the file in response to receiving the request to save, rename or move the file;
generating a suggested pathname using the real-time context data and meta-data;
presenting the suggested pathname to a user; and
wherein the suggested pathname comprises a folder or directory name and a filename.

13. A system for saving, renaming, or moving a file, the system comprising:
a file management module configured to receive a request to save, rename or move a file and generate a request to collect context information for the file in response to the request to save, rename the file;
a context collection module configured to determine real-time context data and meta-data for the file in response to the request to collect context information for the file;
the file management module configured to generate a suggested pathname using the real-time context data;
a user interface module configured to initiate presentation of the suggested pathname to the user; and
wherein the suggested pathname comprises a folder or directory name and a filename.

14. The system of claim 13, wherein the folder or directory name is determined, at least in part, based on the filetype for the file.

15. The system of claim 13, wherein the user interface module is configured to enable the user to edit and approve the suggested pathname.

16. The system of claim 15, wherein the file management module is configured to save the file to the suggested pathname in response to the user approving the suggested pathname.

17. The system of claim 13, wherein the context data comprises one or more of a password hint for the file, storage attributes for the file, collaboration data for the file, calendar data for the user, a file naming policy for an organization.

18. The system of claim 13, wherein the context data comprises a topic determined from content within the file.

19. The system of claim 13, wherein the content comprises one or more of text, an image, video, and real-time IoT data.

20. The system of claim 13, wherein the user interface module is further configured to present multiple suggested pathnames to the user.
